(19) United States
(12) Patent Application Publication
(10) Pub. No.: US 2009/0272708 A1
(43) Pub. Date: Nov. 5, 2009

(54) Modular Counterweight Carriage for Cranes, in Particular for Large Crane

(75) Inventors: Rüdiger Zollondz, Hornbach (DE); Alfons Weckbecker, Zweibruecken (DE); Fritz-Botho Köster, Rockenhausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Terex-Demag GmbH & Co. KG, Zweibrucken (DE)

(21) Appl. No.: 12/085,127

(22) PCT Filed: Oct. 13, 2006
(86) PCT No.: PCT/DE2006/001844

§ 371 Date: May 16, 2008

(30) Foreign Application Priority Data
Nov. 17, 2005 (DE) 102005055693.0
Mar. 1, 2006 (DE) 102006010488.9

(51) Int. Cl. B66C 23/76

(52) U.S. Cl. 212/196

(57) ABSTRACT

A large mobile crane includes a revolving superstructure, a main boom hinged to the superstructure, and a derrick boom hinged to the superstructure. A modular counterweight system includes a traveling counterweight and a non-traveling counterweight connected to a crossbeam suspended from the distal end of the derrick boom so that the non-traveling counterweight is activated before the traveling counterweight.

The invention pertains to all cranes equipped with counterweight carriages, especially to large cranes with a superstructure, with at least one main boom and at least one derrick boom, and with a separate counterweight connected to the tip of the derrick boom.

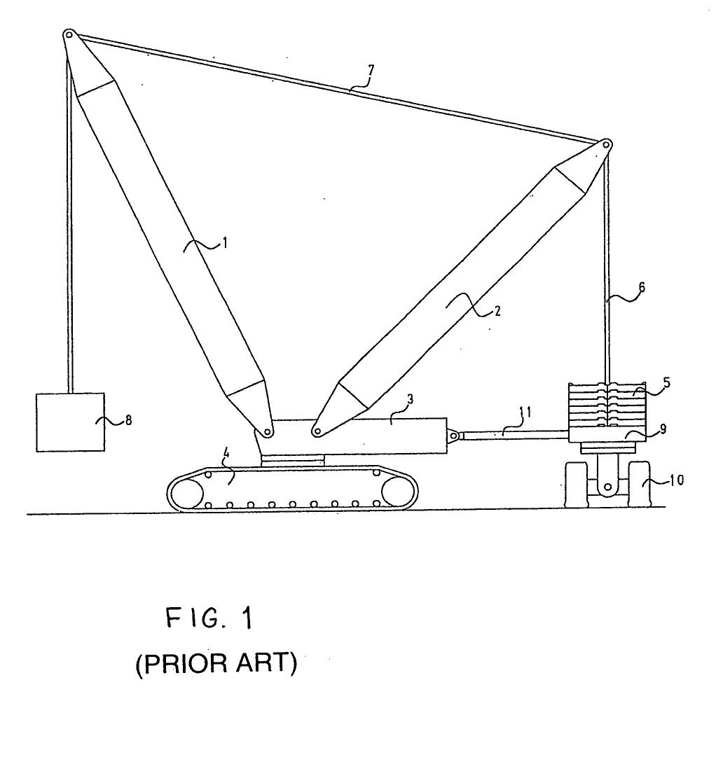

The invention can be used for various types of cranes. These will be explained briefly in the following. In all cases, a main boom 1 and a derrick boom 2 are hinged to a common structure, which is referred to as the superstructure 3. In the case of an inventive crane, the superstructure 3 can move with at least one degree of freedom with respect to the ground or its foundation structure. The various types of cranes differ with respect to their degrees of freedom. In the case of a mobile crane (FIG. 1), the superstructure 3 is connected rotatably to an undercarriage 4, which can travel over the ground on crawlers or wheels. In the case of an outrigger crane, the superstructure is connected rotatably to a chassis, which stands on outriggers resting on the ground or on a pontoon. Mobile cranes can also be combined with outriggers. Another type of crane is the ring-lift crane, where the superstructure rides on a ring-shaped track. The track does not necessarily have to be closed and does not even have to be circular. Other types of cranes can also be imagined, as long as the superstructure has at least one degree of freedom with respect to the ground or its foundation structure, where the term “foundation structure” is understood here to include undercarriages, outriggers, and ring-shaped tracks.

The crane shown here by way of example belongs to the prior art and is a lattice-boom crawler crane, which operates according to the derrick crane principle; that is, the basic machine is designed without ballast and makes no contribution to the stability moment.

So that large loads can be lifted, a relatively large counterweight must be provided because of the basic machine's complete or almost complete the lack of contribution to the stability moment. When the crane rotates or travels, this counterweight must be carried along, too. Known solutions include ballast arrangements which are either lifted from the ground or rest on counterweight carriages with crawlers or wheels.

The disadvantage of the non-traveling ballast arrangements is that, in the case of small-to-medium loads, it is not always possible to raise the ballast, and in the case of derrick cranes it is not usually allowable to do so.

The high ballast weights required to achieve high lifting capacities, however, require large-sized, complicated, and expensive traveling designs. For this purpose, counterweight carriages with either crawlers (Lampson) or wheels have been used so far. In addition to the approach used predominantly in the past in engineering practice, namely, to build a single carriage of appropriate size, it is also possible to use two carriages in a tandem arrangement. Both solutions are complicated, expensive, and hardly suitable for application to small cranes.

The basic idea is explained in the following on the basis of the degree of rotational freedom of a mobile crane. The explanation also applies, however, to general movement of the superstructure in a horizontal plane.

Underneath the previously mentioned derrick boom 2 there is a superlift counterweight 5. This is connected to the tip of the derrick boom 2 by the superlift carrier rods 6. The superlift carrier rods can also be designed as cables, chains, hydraulic cylinders, or other tension elements, and any desired number of them can be provided. The derrick boom 2 is connected to the main boom 1 by main boom retaining rods 7 (whether cables or rods or other tension elements are used is unimportant for the invention). A load 8 on the main boom 1 generates a force in the main boom retaining rods 7, which generates in turn a force in the superlift carrier rods 6. The superlift counterweight 5, which corresponds to the force in the superlift carrier rods (in 6), is referred to as an “activated” superlift counterweight.

So that the crane can rotate, the superlift counterweight 5 is placed on or attached to a counterweight carriage 9. The counterweight carriage has undercarriage with wheels 10 or crawlers. So that the position of the superlift counterweight 5 or of the counterweight carriage 9 with respect to the superstructure 3 can be maintained and in particular so that forces can be transmitted between the superstructure 3 and the counterweight carriage 9 during a movement procedure, a connection 11 is effectively provided between the superstructure 3 and the counterweight carriage 9. Because the loads involved can weigh several hundred tons, counterweight carriages 9 are very expensive individual components and are developed to be used on a crane of a certain capacity.

The task of the present invention is to provide a modular counterweight system which offers the maximum superlift counterweight for the crane in question without requiring a correspondingly large carriage, where the mobility of the crane continues to be guaranteed.

This task is accomplished according to the invention by the features of Claim 1, namely, in that the superstructure has at least one degree of freedom of movement versus the ground or its foundation structure, and in that the counterweight is divided into a traveling counterweight and a non-traveling counterweight, the two counterweights being connected to each other and to the derrick boom in such a way that the non-traveling counterweight can be activated before the traveling counterweight.

Preferred embodiments can be derived from the subclaims.

The one or more counterweights are divided in such a way that the lifting capacity of the traveling counterweight is less than the maximum superlift counterweight possible for the particular crane in question, and in that the non-traveling counterweight makes up the difference between that and the maximum possible superlift weight.

What the superstructure is mounted on is not essential to the invention; that is, it doesn't matter whether it is mounted on a traveling undercarriage, for example, or on a stationary structure resting at least temporarily on the ground.

The essential point is that the superstructure must have at least one degree of freedom of movement versus the ground or its foundation structure, i.e., it must be able to move in the horizontal plane (around the vertical axis) and in particular be able to rotate.

The undercarriage can travel over the ground by means of crawlers or wheels. The superstructure can also be designed as a ring-lift device with the ability to rotate in a horizontal plane on an open or closed ring-shaped track resting on the ground.

According to an inventive elaboration, a crossbeam is provided above the traveling counterweight. This crossbeam is connected in the upward direction to the tip of the derrick boom and in the downward direction both to the traveling counterweight and also to the non-traveling counterweight.

The connection between the crossbeam and the traveling counterweight is designed in such a way that the non-traveling counterweight is lifted first, before the traveling counterweight is activated. A simple design consists of a chain between the crossbeam and the traveling counterweight, the length of the chain being calculated so that it does not become taut until after the non-traveling counterweight has been lifted. Alternatively, rods with a joint or a pin in a slot can be provided instead of a chain.

According to another advantageous design, at least one hydraulic cylinder or reeved cable is provided between the non-traveling counterweight and the crossbeam. As a result, it is possible to vary the length of the connection.

As a result of this inventive design, it becomes possible to reverse the sequence of activation, so that the traveling counterweight is activated first. This makes it possible to make the connection between the crossbeam and the non-traveling counterweight free of force. In this state, the complete non-traveling counterweight can be separated from the crossbeam.

The counterweight can consist of several traveling and non-traveling units which are arranged next to each other, one behind the other, or offset from each other.

The several traveling and non-traveling counterweights can be connected to each other by one or more crossbeams, permanently or detachably, which are arranged next to each other, one behind the other, or offset from each other.

The traveling counterweight can be equipped with its own drive unit.

So that the invention can be understood more clearly, it will be explained in detail below on the basis of the drawings:

FIG. 1 shows a crane with a main boom-derrick boom arrangement;

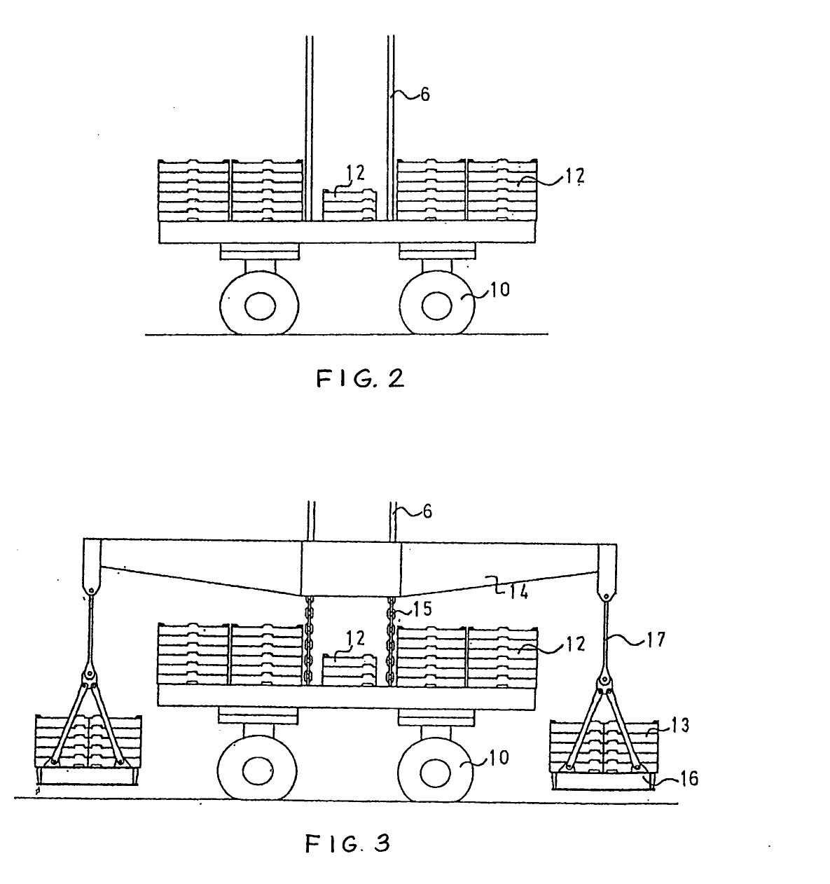

FIG. 2 shows a counterweight carriage; and

FIG. 3 shows an arrangement of traveling and non-traveling counterweight carriage components.

The traveling counterweight is also referred to below as the “counterweight carriage”.

In the present case, a solution made up of existing traveling components and existing or specially designed non-traveling counterweight components is used.

In compliance with the applicable codes, the counterweight is selected so that the test load associated with the nominal lifting capacity can be lifted; that is, at nominal load only part of this counterweight is activated (lifted, without direct or indirect contact with the ground). Only the remainder, the so-called “test load reserve”, must be carried along during the rotation or traveling of the crane with a suspended load. Sufficient for this is an existing, standard counterweight carriage 9, which is supplemented with an additional counterweight 13. Because the counterweight carriage cannot carry the increased counterweight, it remains on the ground initially and is, according to the invention, connected to the tip of the main boom, so that this part of the counterweight is activated first, and only after that is the counterweight located on the counterweight carriage activated.

The design of the existing counterweight carriage 9, preferably with its own drive, also offers the advantage that no additional rotating mechanisms are required in the basic machine in order to rotate the larger masses thus generated. The test load reserve present on the counterweight carriage at all times ensures that slippage is effectively avoided and that the drive power can be transmitted.

The use of the inventive crane with a counterweight carriage which does not have to be designed for the entire superlift counterweight leads to the following advantages:
(a) achievement of the largest possible lifting capacities and radii at modest additional investment cost (only the conversion parts need to be kept on hand);
(b) more effective utilization of the basic investment, because the crane can still work at its original capacity; and
(c) only the counterweight expansion parts need to be transported from one construction site to the next so that cranes of different capacities, especially large cranes, can be built at different locations.

1.-18. (canceled)

19. A crane comprising:
a superstructure having at least one degree of freedom relative to the ground or a foundation structure;
a main boom hinged to the superstructure;
a derrick boom hinged to the superstructure and having a distal end; and
a traveling counterweight and a non-traveling counterweight connected to the distal end of the derrick boom, wherein the counterweights are connected so that the non-traveling counterweight is activated before the traveling counterweight.

20. The crane of claim 19 wherein the crane has a lifting capacity defined as the superlift weight, and requires a superlift counterweight to balance the superlift weight, wherein the sum of the traveling counterweight and the non-traveling counterweight equals the superlift counterweight.

21. The crane of claim 19 further comprising a crossbeam suspended from the distal end of the derrick boom, the traveling counterweight and the non-traveling counterweight being connected to the crossbeam.

22. The crane of claim 21 wherein the traveling counterweight and the non-traveling counterweight are connected to the crossbeam so that the non-traveling counterweight is lifted before the traveling counterweight is activated.

23. The crane of claim 21 wherein the crossbeam is connected to the non-traveling counterweight by a hydraulic cylinder.

24. The crane of claim 21 wherein the crossbeam is connected to the non-traveling counterweight by a reeved cable.

25. The crane of claim 21 wherein at least one of the traveling and non-traveling counterweights comprises a plurality of counterweights.

26. The crane of claim 25 wherein the counterweights are suspended in tandem along the crossbeam.

27. The crane of claim 26 wherein the non-traveling counterweights are arranged at opposite ends of the crossbeam, with the traveling counterweight therebetween.

28. The crane of claim 19 wherein the traveling counterweight is equipped with a drive.

29. The crane of claim 19 further comprising a traveling undercarriage which serves as the foundation structure, the superstructure being rotatable relative to the traveling undercarriage.

30. The crane of claim 29 wherein the traveling undercarriage is equipped with one of crawlers and wheels.

31. The crane of claim 19 further comprising a non-traveling undercarriage which serves as the foundation structure, the superstructure being rotatable in a horizontal plane relative to the non-traveling undercarriage.

32. The crane of claim 19 further comprising a ring-shaped track which serves as the foundation structure, the superstructure comprising a ring-lift unit which is able to rotate in a horizontal plane on the track.
